(19) United States
(12) Patent Application Publication
(10) Pub. No.: US 2007/0049156 A1
(43) Pub. Date: Mar. 1, 2007

(54) Method of manufacturing plasma display panel

(75) Inventor: Jongrae Lim, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/507,571

(22) Filed: Aug. 22, 2006

(30) Foreign Application Priority Data
Aug. 23, 2005 (KR) 10-2005-0077412

(51) Int. Cl. H01J 9/12

(52) U.S. Cl. 445/49

(57) ABSTRACT

A method of manufacturing a plasma display panel is disclosed. The method includes forming a first dielectric layer on the electrode and the substrate, coating a dielectric material on at least a portion of the first dielectric layer, and firing the dielectric material to form a second dielectric layer.

This Nonprovisional application claims priority under 35 U.S.C. § 119(a) on patent application Ser. No. 10-2005-0077412 filed in Korea on Aug. 23, 2005 the entire contents of which are hereby incorporated by reference.

### BACKGROUND OF THE INVENTION

1. Field of the Invention

This document relates to a method of manufacturing a plasma display panel.

2. Description of the Related Art

Out of display apparatuses, a plasma display apparatus comprises a plasma display panel and a driver for driving the plasma display panel.

The plasma display panel comprises a front panel, a rear panel and barrier fibs formed between the front panel and the rear panel. The barrier ribs form unit discharge cell or discharge cells. Each of the discharge cell is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

The plasma display panel comprises a front substrate on which scan electrodes and sustain electrodes are formed, and a rear substrate on which address electrodes are formed. On the front substrate, an upper dielectric layer for providing insulation of the scan electrodes and the sustain electrodes and for forming wall charges is formed. On the rear substrate, a lower dielectric layer for providing insulation between the address electrodes is formed.

### SUMMARY OF THE INVENTION

In an aspect, there is provided a method of manufacturing a plasma display panel comprising an electrode formed on a substrate, comprising forming a first dielectric layer on the electrode and the substrate, coating a dielectric material on at least a portion of the first dielectric layer, and firing the dielectric material to form a second dielectric layer.

In another aspect, there is provided a method of manufacturing a plasma display panel comprising forming an electrode on a substrate, coating a dielectric material on the electrode and the substrate, and firing the dielectric material to form a dielectric layer, wherein the amount of the dielectric material coated on at least a portion of the electrode is more than the amount of the dielectric material coated on the remaining region.

### BRIEF DESCRIPTION OF THE DRAWINGS

The accompany drawings, which are included to provide a further understanding of embodiments and are incorporated in and constitute a part of this specification, illustrate embodiments of the invention and together with the description serve to explain the principles of the embodiments. In the drawings:

FIGS. 1 and 2 illustrate a plasma display panel according to exemplary embodiments;

FIGS. 3a to 3d illustrate a method of manufacturing a plasma display panel according to a first embodiment;

FIGS. 4a to 4d illustrate a method of manufacturing a plasma display panel according to a second embodiment;

FIG. 5 is a cross-sectional view of a dispensing device according to the first embodiment;

FIG. 6 is a cross-sectional view of a dispensing device according to the second embodiment;

### DETAILED DESCRIPTION OF PREFERRED EMBODIMENTS

Embodiments will be described in a more detailed manner with reference to the drawings.

A method of manufacturing a plasma display panel comprising an electrode formed on a substrate, comprises forming a first dielectric layer on the electrode and the substrate, coating a dielectric material on at least a portion of the first dielectric layer, and firing the dielectric material to form a second dielectric layer.

The permittivity of the dielectric material may be more than the permittivity of the first dielectric layer.

The permittivity of the first dielectric layer may range from 10 to 12, and the permittivity of the dielectric material may range from 12 to 15.

A material of the first dielectric layer may be substantially the same as the dielectric material.

The dielectric material may be coated on at least a portion of the first dielectric layer formed on the electrode.

The electrode may comprise a scan electrode and a sustain electrode.

The dielectric material and the first dielectric layer may be fired simultaneously.

The dielectric material may be coated using either a dispensing method or an inkjet printing method.

A method of manufacturing a plasma display panel comprises forming an electrode on a substrate, coating a dielectric material on the electrode and the substrate, and firing the dielectric material to form a dielectric layer, wherein the amount of the dielectric material coated on at least a portion of the electrode is more than the amount of the dielectric material coated on the remaining region.

The dielectric material may be coated using a dispensing method.

The coating time of the dielectric material or the discharge amount of the dielectric material per hour may determine the coating amount of the dielectric material.

The electrode may comprise a scan electrode and a sustain electrode.

Hereinafter, exemplary embodiments of the present invention will be described in detail with reference to the attached drawings.

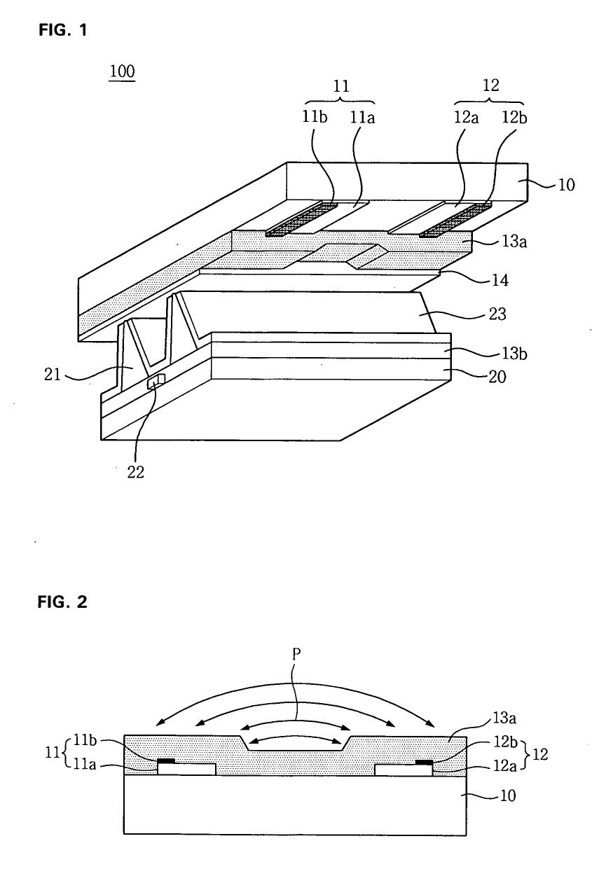

FIGS. 1 and 2 illustrate a plasma display panel according to exemplary embodiments. A plasma display panel 100 according to the exemplary embodiments comprises a front substrate 10 on which a scan electrode 11 and a sustain electrode 12 are formed, and a rear substrate 20 on which an address electrodes 22 is formed.

The scan electrode 11 and the sustain electrode 12 each comprise transparent electrodes 11a and 12a made of indium-tin-oxide (ITO) and bus electrodes 11b and 12b made of Cu or Ag.

An upper dielectric layer 13a is formed on the scan electrode 11 and the sustain electrode 12. A protective layer 14 is formed on the upper dielectric layer 13a to protect the scan electrode 11, the sustain electrode 12 and the upper dielectric layer 13a and to facilitate secondary electron emission.

The thickness of the upper dielectric layer 13a formed on at least a portion of the scan electrode 11 and the sustain electrode 12 is more than the thickness of the upper dielectric layer 13a formed on at least a portion of the remaining region. The upper dielectric layer 13a of the plasma display panel 100 according to the exemplary embodiments will be described in detail later with reference to the attached drawings.

A lower dielectric layer 13b is formed on the address electrode 22. Barrier ribs 21 are formed on the lower dielectric layer 13b. A phosphor layer 23 is formed between the barrier ribs 21.

A discharge cell is defined by a location of each of the scan electrode 11, the sustain electrode 12, the barrier rib 21 and the address electrode 22. The discharge cell is filled with an inert mixture gas.

An image is displayed on the plasma display panel due to a reset discharge, an address discharge and a sustain discharge. The reset discharge makes wall charges of the discharge cells uniform. The address discharge occurs between the scan electrode 11 and the sustain electrode 12 to select discharge cells where the sustain discharge will occur. The sustain discharge occurs in the discharge cell selected by performing the address discharge. When a sum of a wall voltage generated by wall charges accumulated on the scan electrode 11 and the sustain electrode 12 and a difference of voltages supplied to each of the scan electrode 11 and the sustain electrode 12 is more than a firing voltage, the sustain discharge starts to occur.

The plasma display panel according to the exemplary embodiments comprises a differential dielectric layer as the upper dielectric layer 13a, thereby lowering the firing voltage. The thickness of a portion of the differential dielectric layer is different from the thickness of another portion of the differential dielectric layer. As illustrated in FIG. 2, since the differential dielectric layer reduces the length of a discharge path P, the firing voltage is lowered. Further, since the differential dielectric layer reduces the average thickness of the upper dielectric layer 13a, the firing voltage is lowered. Since the thickness of a portion of the upper dielectric layer 13a corresponding to the scan electrode 11 and the sustain electrode 12 is more than the average thickness of the upper dielectric layer 13a, a discharge current decreases and the discharge efficiency increases.

The following is a detailed description of a method of manufacturing the plasma display panel according to the exemplary embodiments, with reference to the attached drawings.

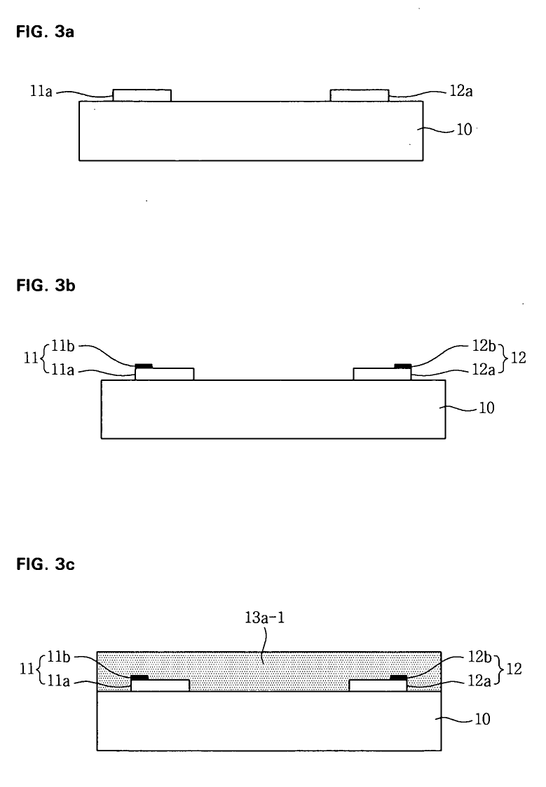

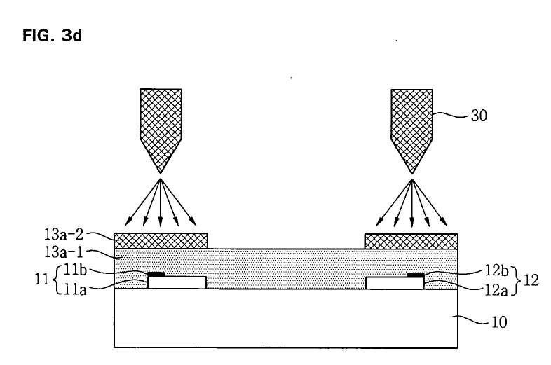

FIGS. 3a to 3d illustrate a method of manufacturing the plasma display panel according to a first embodiment.

As illustrated in FIG. 3a, the transparent electrode 11a for the scan electrode 11 and the transparent electrode 12a for the sustain electrode 12 are formed on the front substrate 10.

As illustrated in FIG. 3b, the bus electrode 11b for the scan electrode 11 and the bus electrode 12b for the sustain electrode 12 are formed on the transparent electrode 11a for the scan electrode 11 and the transparent electrode 12a for the sustain electrode 12, respectively. The bus electrodes 11b and 12b comprise Cu or Ag.

As illustrated in FIG. 3c, a first dielectric layer 13a-1 is formed on the transparent electrode 11a for the scan electrode 11, the transparent electrode 12a for the sustain electrode 12, the bus electrode 11b for the scan electrode 11, the bus electrode 12b for the sustain electrode 12 and the front substrate 10. The first dielectric layer 13a-1 is formed on the entire surface of the front substrate 10. The first dielectric layer 13a-1 maybe formed using a screen printing method, a laminating method using a green sheet, and the like.

As illustrated in FIG. 3d, a dielectric material 13a-2 is coated on at least a portion of the first dielectric layer 13a-1 using a dispensing device 30. In other words, the dielectric material 13a-2 is coated on at least a portion of the first dielectric layer 13a-1 formed on the scan electrode 11 and the sustain electrode 12 using the dispensing device 30. The thickness of the upper dielectric layer 13a having the dielectric material 13a-2 is more than the thickness of the upper dielectric layer 13a in which the dielectric material 13a-2 is not formed, thereby forming the differential dielectric layer. A material of the first dielectric layer 13a-1 may be the same as the dielectric material 13a-2.

Further, the dielectric material 13a-2 may be coated using an inkjet printer (not shown). In the same way as the dispensing device 30 by which the dielectric material 13a-2 is coated on at least a portion of the first dielectric layer 13a-1 formed on the scan electrode 11 and the sustain electrode 12 through a nozzle, the dielectric material 13a-2 may be coated on at least a portion of the first dielectric layer 13a-1 formed on the scan electrode 11 and the sustain electrode 12 through a nozzle of the inkjet printer.

The permittivity of the dielectric material 13a-2 may be more than the permittivity of the first dielectric layer 13a-1. For example, the permittivity of the dielectric material 13a-2 may range from 12 to 15, and the permittivity of the first dielectric layer 13a-1 may range from 10 to 12. When the permittivity of the dielectric material 13a-2 is more than the permittivity of the first dielectric layer 13a-1, the amount of wall charges formed by performing an opposite discharge type of an address discharge between the scan electrode 11 and the address electrode (not shown) increases such that the discharge efficiency increases.

When forming the differential dielectric layer using a photolithography method, the manufacturing cost increases due to the use of a photo mask, and the manufacturing method of the plasma display panel is complicated and the manufacturing time increases due to the performance of an exposing process and a developing process. Further, since a dielectric material is coated on the entire surface of the front substrate 10 and then is developed, the manufacturing cost increases. However, in the method of manufacturing the plasma display panel according to the first embodiment, since the differential dielectric layer is formed using the dispensing method, the manufacturing cost decreases, the manufacturing method is simple, and the manufacturing time decreases. Further, an increase in the manufacturing cost caused by the developing process is prevented.

Afterwards, a firing process is performed to complete the differential dielectric layer.

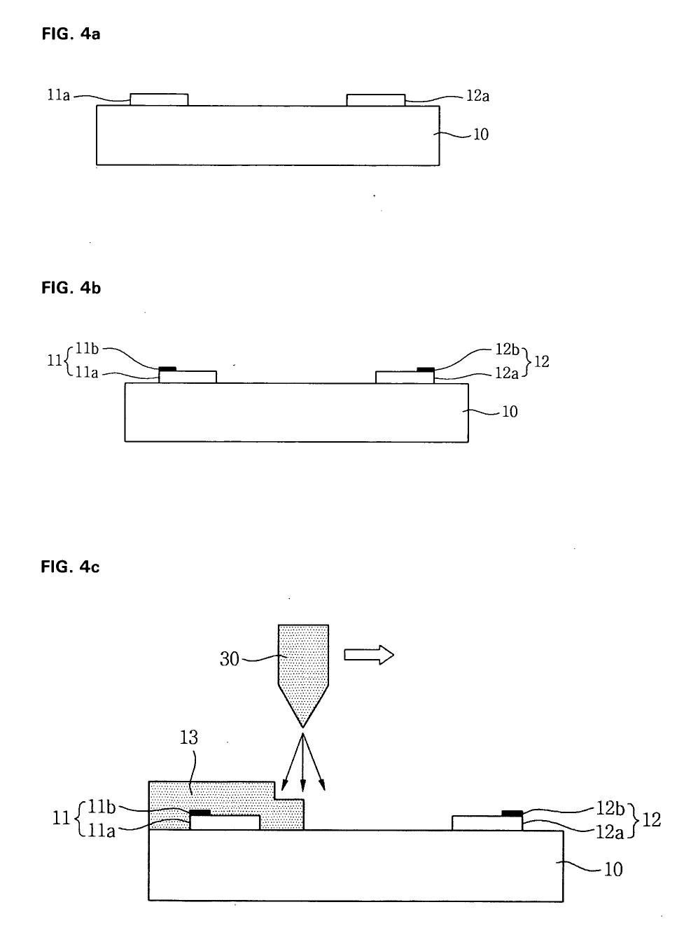

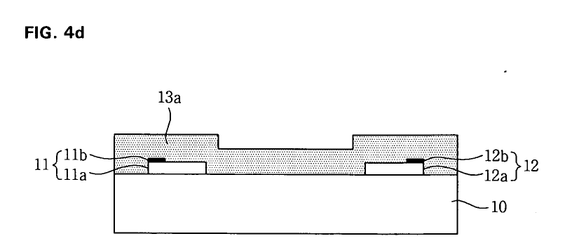

FIGS. 4a to 4d illustrate a method of manufacturing a plasma display panel according to a second embodiment.

As illustrated in FIG. 4a, the transparent electrode 11a for the scan electrode 11 and the transparent electrode 12a for the sustain electrode 12 are formed on the front substrate 10.

As illustrated in FIG. 4b, the bus electrode 11b for the scan electrode 11 and the bus electrode 12b for the sustain electrode 12 are formed on the transparent electrode 11a for the scan electrode 11 and the transparent electrode 12a for the sustain electrode 12, respectively. The bus electrodes 11b and 12b comprise Cu or Ag.

As illustrated in FIG. 4c, a dielectric material 13 is coated on the scan electrode 11, the sustain electrode 12 and the front substrate 10 using a dispensing device 30. The amount of the dielectric material 13 coated on at least a portion of the scan electrode 11 and the sustain electrode 12 is more than the amount of the dielectric material 13 coated on the remaining region. Accordingly, the thickness of the dielectric material 13 coated on at least a portion of the scan electrode 11 and the sustain electrode 12 is more than the thickness of the dielectric material 13 coated on the remaining region. The dispensing device 30 controls the coating amount of the dielectric material 13 by the coating time of the dielectric material or the discharge amount of the dielectric material per hour.

As illustrated in FIG. 4d, the dielectric material 13 is fired to complete the differential dielectric layer.

As illustrated in FIGS. 4a to 4d, since the differential dielectric layer is formed using the dispensing method in the method of manufacturing the plasma display panel according to the second embodiment, the manufacturing time of the plasma display panel decreases. In particular, since a photo mask used in a photolithography method is not required and an exposing process and a developing process are not performed in the method of manufacturing the plasma display panel according to the second embodiment, the manufacturing cost and the manufacturing time decrease.

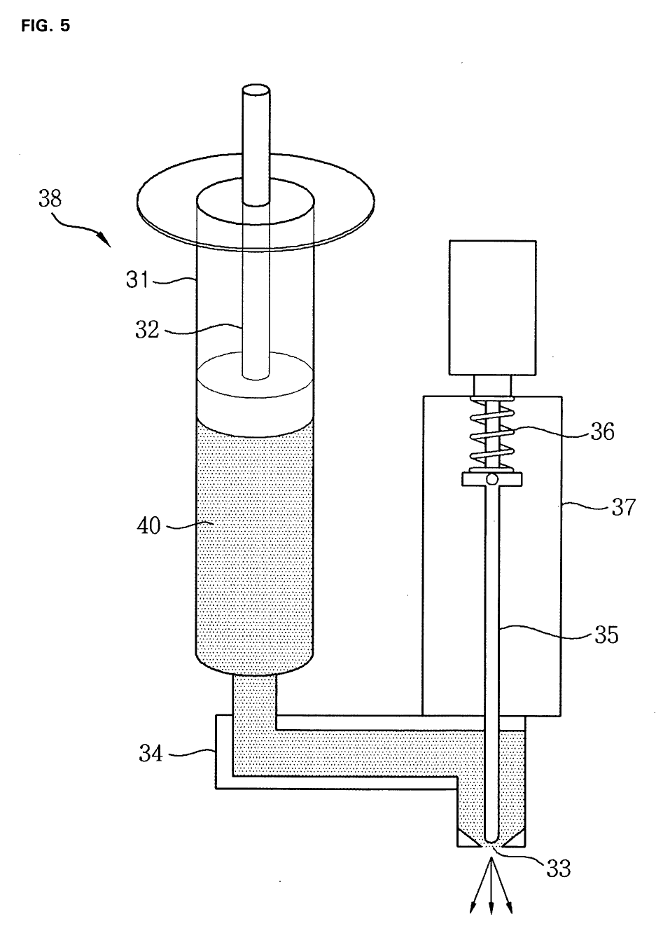

FIG. 5 is a cross-sectional view of a dispensing device according to the first embodiment.

As illustrated in FIG. 5, the dispensing device according to the first embodiment comprises a tank 38 having a cylinder 31 and a pressure piston 32, a micro nozzle 33, a connecting tube 34, an open-and-shut piston 35 and a housing 37. The dispensing device according to the first embodiment further comprises a return spring 36.

The tank 38 comprises the cylinder 31 and the pressure piston 32. The cylinder 31 stores a dielectric material 40 to be coated. The pressure piston 32 pressurizes the dielectric material 40 stored in the cylinder 31 to discharge the dielectric material 40 through the micro nozzle 33. The tank 38 and the housing 37 are configured independently. However, the tank 38 and the housing 37 are configured adjacently such that the housing 37 may perform a function of the connecting tube 34.

The micro nozzle 33 is connected to the connecting tube 34 to discharge the dielectric material 40 transferred through the tank 38 and the connecting tube 34. The connecting tube 34 is a transfer passage of the dielectric material 40 transferred from the tank 38 to the micro nozzle 33. The connecting tube 34 connects the tank 38 to the micro nozzle 33. The connecting tube 34 may be formed of a material such as a metal, glass, plastic, and may be a flexible tube.

A diameter of the open-and-shut piston 35 may be substantially equal to or more than a diameter of the micro nozzle 33. The open-and-shut piston 35 opens and shuts the micro nozzle 33. To increase the strength of the open-and-shut piston 35, a diameter of a portion of the open-and-shut piston 35 which touches the micro nozzle 33 may be substantially equal to the diameter of the micro nozzle 33. A diameter of an upper portion of the open-and-shut piston 35 may be more than the diameter of the micro nozzle 33. The open-and-shut piston 35 opens and shuts the micro nozzle 33 by repeating over and over again an up-and-down motion of the open-and-shut piston 35 (i.e., a reciprocating motion of the open-and-shut piston 35).

The housing 37 has a sufficient space for the reciprocating motion of the open-and-shut piston 35, and protects the open-and-shut piston 35.

The return spring 36 is fixed to one end of the housing 37 inside the housing 37, and is connected to the open-and-shut piston 35. After the up-and-down motion of the open-and-shut piston 35, the open-and-shut piston 35 returns to an original position by an elastic action of the return spring 36. Accordingly, the micro nozzle 33 efficiently opens and shuts. The return spring 36 may be a sheet type spring or a coil type spring.

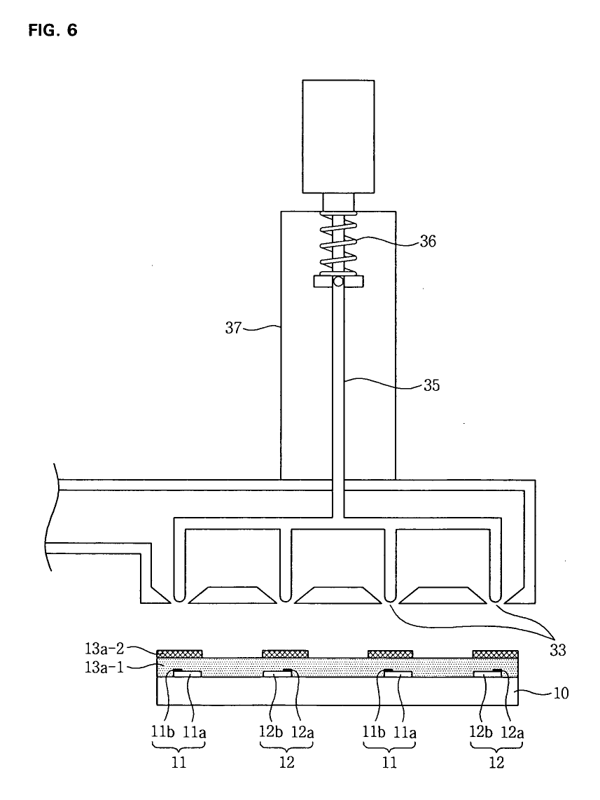

FIG. 6 is a cross-sectional view of a dispensing device according to the second embodiment.

As illustrated in FIG. 6, the dispensing device according to the second embodiment simultaneously discharges a dielectric material through a plurality of micro nozzles 33, thereby efficiently performing the discharge of the dielectric material.

A distance between a plurality of open-and-shut pistons 35 and a distance between the plurality of micro nozzles 33 are substantially equal to a distance between the differential dielectric layers. Further, the plurality of open-and-shut pistons 35 are formed independently such that the plurality of open-and-shut pistons 35 independently open and shut the plurality of micro nozzles 33.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A method of manufacturing a plasma display panel comprising an electrode formed on a substrate, comprising:
forming a first dielectric layer on the electrode and the substrate;
coating a dielectric material on at least a portion of the first dielectric layer, and
firing the dielectric material to form a second dielectric layer.

2. The method of claim 1, wherein the permittivity of the dielectric material is more than the permittivity of the first dielectric layer.

3. The method of claim 1, wherein the permittivity of the first dielectric layer ranges from 10 to 12, and the permittivity of the dielectric material ranges from 12 to 15.

4. The method of claim 1, wherein a material of the first dielectric layer is substantially the same as the dielectric material.

5. The method of claim 1, wherein the dielectric material is coated on at least a portion of the first dielectric layer formed on the electrode.

6. The method of claim 5, wherein the electrode comprises a scan electrode and a sustain electrode.

7. The method of claim 1, wherein the dielectric material and the first dielectric layer are fired simultaneously.

8. The method of claim 1, wherein the dielectric material is coated using either a dispensing method or an inkjet printing method.

9. A method of manufacturing a plasma display panel comprising:
forming an electrode on a substrate;
coating a dielectric material on the electrode and the substrate; and
firing the dielectric material to form a dielectric layer,
wherein the amount of the dielectric material coated on at least a portion of the electrode is more than the amount of the dielectric material coated on the remaining region.

10. The method of claim 9, wherein the dielectric material is coated using a dispensing method.

11. The method of claim 10, wherein the coating time of the dielectric material or the discharge amount of the dielectric material per hour determines the coating amount of the dielectric material.

12. The method of claim 9, wherein the electrode comprises a scan electrode and a sustain electrode.
